(19) United States
(12) Patent Application Publication
(10) Pub. No.: US 2010/0186883 A1
(43) Pub. Date: Jul. 29, 2010

(54) METHOD OF TRANSFERRING A DEVICE AND METHOD OF MANUFACTURING A DISPLAY APPARATUS

(75) Inventor: Katsuhiro TOMODA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/647,826

(22) Filed: Dec. 28, 2009

(30) Foreign Application Priority Data
Jan. 29, 2009 (JP) 2009-017468

(51) Int. Cl. B32B 37/02

(52) U.S. Cl. 156/220

(57) ABSTRACT

A method of transferring a device includes: arranging a release layer and a device in the stated lamination order on a first substrate having light transmitting property via a bonding layer having light transmitting property; arranging an adhesive layer formed on a second substrate so that the adhesive layer is opposed to a surface of the first substrate on which the device is arranged; and ablating the release layer by performing light irradiation on the release layer from the first substrate side and transferring the device onto the second substrate with the bonding layer being left on the first substrate.

### BACKGROUND OF THE INVENTION

1. Field of the Invention

The present invention relates to a method of transferring a device and a method of manufacturing a display apparatus, and more particularly, to a method of transferring a device from a first substrate side to a second substrate side by an ablation technique and a method of manufacturing a display apparatus using the method of transferring a device.

2. Description of the Related Art

In the manufacture of a display apparatus in which light emitting diodes (LEDs) are arranged, a process of transferring the LEDs, which are arranged on a wafer at a fine pitch, onto an apparatus substrate in a state where the LEDs are rearranged in accordance with an enlarged pitch corresponding to a pixel array is conducted. This transfer process, to which an ablation technique is applied, is conducted as follows, for example.

First, devices (light emitting diodes) are arranged on a release layer formed on a first substrate, the release layer being made of a resin material and having bonding property. Then, a surface of a second substrate on which an adhesive layer is formed is arranged so as to face the surface of the first substrate on which the devices are arranged and a laser beam is selectively irradiated, from the first substrate side, onto only a position corresponding to a device that is a target to be transferred. By the laser irradiation, the device is separated from the first substrate side by instantaneously evaporating (ablating) the release layer formed on the first substrate and the separated device is bonded and fixed to the adhesive layer formed on the second substrate.

In the ablation technique described above, it is proposed a structure in which a light absorbing layer made of, for example, a metal material is provided between the release layer (resin layer) and the devices and light is irradiated onto the light absorbing layer. In such a structure, the release layer (resin layer) is ablated by heat generated by the light absorbing layer, and accordingly the release layer (resin layer) can be ablated using light of a long wavelength as compared to a UV region (see Japanese Patent Application Laid-open No. 2005-45074 (see, for example, FIG. 1 and paragraph 0012)).

### SUMMARY OF THE INVENTION

However, in the device transfer method to which the ablation technique described above is applied, the light absorbing layer is not ablated but the release layer is ablated by the heat generated by the light absorbing layer. Therefore, there arise problems that a degree of flexibility in selection of the light absorbing layer and the release layer is low and an appropriate range of laser energy capable of being transferred is narrow. In addition, the release layer removed by ablation also serves as a bonding layer between the devices and the first substrate. Consequently, it has been difficult to design a material that has a sufficient bonding force to the extent that the devices on the first substrate can be subjected to processing treatment but is easy to be ablated by light irradiation, for example.

According to an embodiment of the present invention, there is provided a method of transferring a device. The method is performed as follows. First, a release layer and a device are arranged in the stated lamination order on a first substrate having light transmitting property via a bonding layer having light transmitting property. Next, an adhesive layer formed on a second substrate is arranged so that the adhesive layer is opposed to a surface of the first substrate on which the device is arranged. In this state, the release layer is ablated by performing light irradiation on the release layer from the first substrate side and the device is transferred onto the second substrate with the bonding layer being left on the first substrate.

Further, according to another embodiment of the present invention, there is provided a method of manufacturing a display apparatus, the method including a process of transferring a light emitting device from a first substrate onto a second substrate in the procedure described above.

Since in such a structure, the release layer provided on the device side with respect to the bonding layer is ablated and the device (light emitting diode) is transferred from the first substrate onto the second substrate, the device is transferred to the second substrate side without the bonding layer left on the device side. In addition, by providing the bonding layer and the release layer separately, it is possible to reliably transfer the device owing to the release layer that has a wide appropriate range of laser energy for ablation and is easy to be ablated while sufficiently ensuring bonding property between the first substrate and the device owing to the bonding layer.

According to the embodiments of the present invention, by providing the bonding layer and the release layer separately, it is possible to sufficiently ensure bonding property between the first substrate and the device owing to the bonding layer and reliably transfer the device owing to the release layer that is easy to be ablated. As a result, the device can be subjected to processing treatment on the first substrate, for example. Further, since the device can be transferred onto the second substrate without the bonding layer being left on the device side, a remove process of the bonding layer is not necessary after the transfer.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 are cross-sectional process views (part 1) for explaining a first embodiment;

FIG. 2 are cross-sectional process views (part 2) for explaining the first embodiment;

FIG. 3 are cross-sectional process views (part 3) for explaining the first embodiment;

FIG. 4 is a circuit diagram showing an example of a display apparatus manufactured by applying the embodiment of the present invention;

FIG. 5 are cross-sectional process views (part 1) for explaining a second embodiment; and

FIG. 6 are cross-sectional process views (part 2) for explaining the second embodiment.

### DESCRIPTION OF PREFERRED EMBODIMENTS

Hereinafter, embodiments of the present invention will be described in the following order.

1. First embodiment (example in which light emitting devices are isolated on relay substrate)

2. Second embodiment (example in which light emitting devices are isolated on growth substrate for forming devices)

It should be noted that in the first embodiment and the second embodiment, a manufacturing procedure of a display device in which light emitting devices are arranged on an apparatus substrate, to which the embodiments of the present invention are applied, will be described.

### 1. First Embodiment

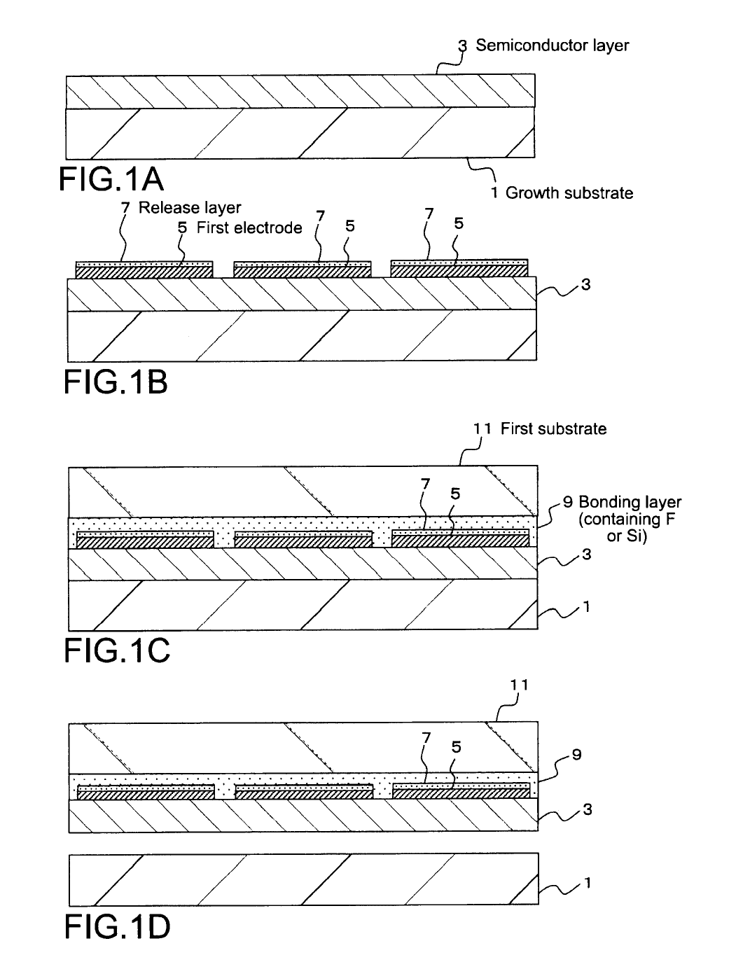

First, as shown in FIG. 1A, a semiconductor layer 3 having a layer structure is epitaxially grown on a substrate 1 for growing semiconductor crystal (hereinafter, referred to as growth substrate 1), the growth substrate 1 being made of sapphire or the like. Here, a compound semiconductor layer of a first conductivity type (for example, n-type), an active layer, and a compound semiconductor layer of a second conductivity type (for example, p-type) are first epitaxially grown by a crystal growth method such as an MO-CVD method in the stated order, to thereby form the semiconductor layer 3.

Next, as shown in FIG. 1B, first electrodes 5 and release layers 7 are formed and arranged on the semiconductor layer 3.

Each of the first electrodes 5 is a second conductivity type electrode (for example, p-electrode) and is formed to have a layer structure in which platinum (Pt) and gold (Au) are laminated on nickel (Ni). Further, in a case where the first electrode 5 is used as a photothermal conversion layer in an ablation process performed later, it is desirable to constitute the first electrode 5 by using a conductive material capable of efficiently absorbing light and converging energy of the light into heat. Such a material is, for example, titanium (Ti), nichrome (Cr), and nickel (Ni).

Further, each of the release layers 7 is formed using a material that is easily ablated by light irradiation. Such a release layer 7 desirably has an absorption coefficient of 1×10⁶ [m⁻¹] or more with respect to light (laser beam) used in the ablation process performed later and has a film thickness of 1 μm or less. Specifically, it is assumed that the release layer 7 has an absorption coefficient of 1×10⁷ [m⁻¹] or more with respect to light having a wavelength of 190 nm or more, which is used in reality in light irradiation of the ablation, and has a film thickness of about 0.1 μm. As such a material, resin materials such as polyimide and polyphenylenebenzo bisoxazole may be used. It should be noted that the material constituting the release layer 7 is not limited to the resin material, and may be a metal material. In a case where a metal material constituting the first electrode 5 is selected as the metal material constituting the release layer 7, a surface layer of the first electrode 5 may be used as the release layer 7.

The first electrode 5 and the release layer 7 as described above are formed by patterning by, after material films constituting the first electrode 5 and the release layer 7 are formed, applying pattern-etching or a lift-off method to the material films.

Subsequently, as shown in FIG. 1C, a first substrate 11 is bonded to the growth substrate 1 on which the semiconductor layer 3, the first electrodes 5, and the release layers 7 are formed, via an uncured bonding layer 9.

Of those, it is important for the bonding layer 9 to have light transmitting property with respect to light of a wavelength used in the ablation process executed later, and is desirable for the bonding layer 9 to have an absorption coefficient of 1×10⁶ [m⁻¹] or less with respect to light (laser beam) used in the ablation process. Specifically, it is desirable that an absorption coefficient of light having a wavelength of 190 nm or more, which is used in reality in light irradiation of the ablation, be 1×10⁴ [m⁻¹] or less.

For example, in a case where a pulse laser beam of a wavelength of 450 nm or less is used as the light, the bonding layer 9 is desirably formed of a material containing at least one of fluorine (F) and silicon (Si) or an ionomer resin material. Examples of such a material include amorphous fluorinated polymer, cyclic fluorinated polymer not having a conjugated bond, and fluorinated polymer not having chromophore of a wavelength of 450 nm or less, if the material contains fluorine (F). Further, if the material contains silicon (Si), examples of the material include a dimethyl silicone resin not having chromophore of a wavelength having 450 nm or less. Moreover, if the material is the ionomer resin material, examples of the material include a polyolefin-based ionomer. Those materials exhibit high transmitting property with respect to light having wavelength of 450 nm or less.

Though the first substrate 11 is used as a support substrate for relay, it is important to form the first substrate 11 of a material that causes light used in the ablation performed later to pass therethrough. Accordingly, the first substrate 11 is formed of, for example, a material substrate excellent in light transmitting property, such as sapphire.

It should be noted that the bonding layer 9 is applied to one of the growth substrate 1 and the first substrate 11 in advance by spin coating, for example. In this case, in consideration of ensuring of surface flatness of the bonding layer 9, it is desirable to apply the bonding layer 9 onto the first substrate 11 having higher surface flatness at this time. Moreover, after the growth substrate 1 and the first substrate 11 are bonded to each other, the bonding layer 9 is cured.

After the above operations, as shown in FIG. 1D, the growth substrate 1 is separated and removed from the semiconductor layer 3, and thereafter the release layers 7, the first electrodes 5, and the semiconductor layer 3 are transferred onto the first substrate 11. In this case, an interface between the growth substrate 1 and the semiconductor layer 3 is ablated by laser irradiation from the first substrate 11 side, and thus the growth substrate 1 is separated and removed from the semiconductor layer 3.

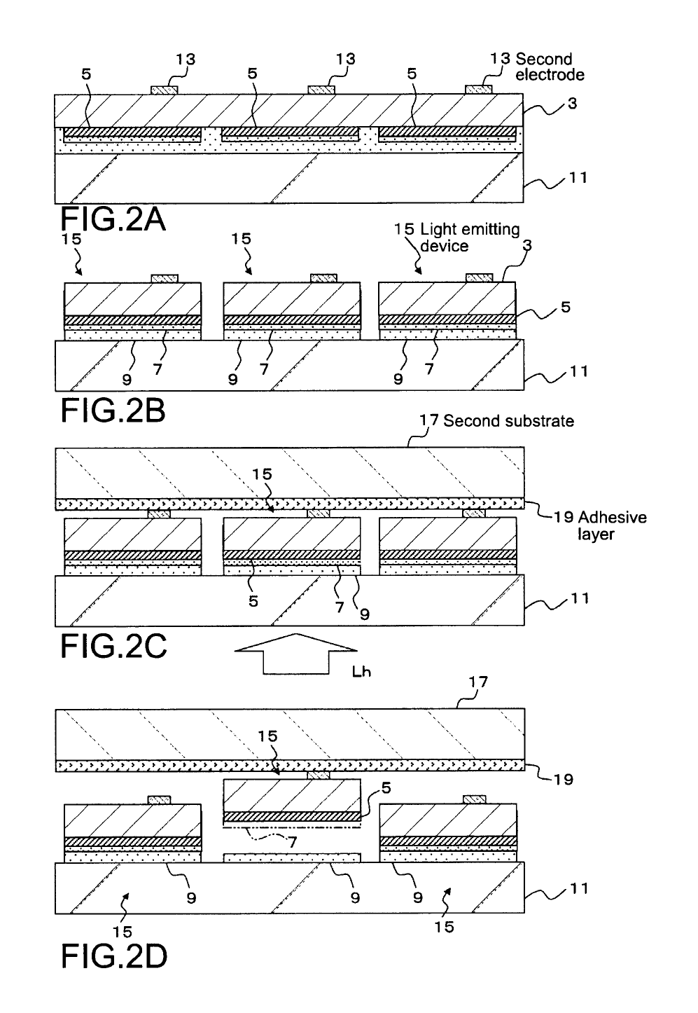

Next, as shown in FIG. 2A, second electrodes 13 are formed and arranged on the semiconductor layer 3. Each of the second electrodes 13 is a first conductivity type electrode (for example, n-electrode) and is formed using a laminated structure in which platinum (Pt) and gold (Au) are laminated on titanium (Ti), for example. Each of the second electrodes 13 is formed by patterning on a device portion corresponding to a position of each of the first electrodes 5. In this case, after material films constituting the second electrodes 13 are formed, for example, the second electrodes 13 are formed by patterning by pattern-etching the material films or applying a lift-off method thereto.

Next, as shown in FIG. 2B, device isolation is performed by pattern-etching the semiconductor layer 3, and there is obtained a state where a plurality of light emitting devices (light emitting diodes) 15 are formed and arranged on the first substrate 11. In this case, the bonding layer 9 formed on the first substrate 11 may also be etched with the same pattern as that of the semiconductor layer 3. Alternatively, the bonding layer 9 may be left as it is on the first substrate 11 as a solid film without being patterned.

Through the above operations, the state where the release layers 7 and the light emitting devices 15 are laminated in this order on the first substrate 11 having light transmitting property via the bonding layer 9 having light transmitting property is obtained.

After that, as shown in FIG. 2C, a surface of a second substrate 17 on which an adhesive layer 19 is formed is opposed to the surface of the first substrate 11 on which the light emitting devices 15 are arranged, and the second substrate 17 is bonded to the first substrate 11 via the adhesive layer 19. In this case, the first substrate 11 and the second substrate 17 are press-fitted by mutually being pressed.

The second substrate 17 used here is a support substrate for relay, and does not need to have light transmitting property in particular. Accordingly, the second substrate 17 may be made of a normal glass substrate.

Further, the adhesive layer 19 is not needed to have such bonding property that is requisite for the bonding layer 9 and only needs to have slight adhesiveness. Furthermore, the adhesive layer 19 may have property of holding the second electrodes 13 provided on the light emitting device 15 side while causing the second electrodes 13 to dig into the adhesive layer 19 in a case where the first substrate 11 and the second substrate 17 are brought into press-contact with each other. Accordingly, the adhesive layer 19 absorbs asperities made due to the light emitting devices 15 and bonded in a wide area.

In this state, light irradiation is performed by irradiating a laser beam Lh onto only a selected light emitting device 15 from the first substrate 11 side, which is made of sapphire or the like. Thus, the laser beam Lh is irradiated onto a release layer 7 while passing through an bonding layer 9 corresponding to the selected light emitting device 15, and accordingly the release layer 7 is ablated. In this light irradiation, a pulse laser beam Lh having a wavelength of 450 nm or less is used, for example.

It should be noted that it is important to select, as the laser beam Lh used at this time, a laser beam having a wavelength or pulse energy that causes a large difference between the bonding layer 9 and the release layer 7 in absorption coefficient and can sublimate the release layer 7 by laser ablation. As such a laser beam Lh, a YAG laser having a wavelength of 266 nm, an excimer laser having a wavelength of 248 nm, an excimer laser having a wavelength of 193 nm, and the like are used.

Moreover, the light irradiation is desirably performed using energy with which the release layer 7 is completely ablated and removed. For example, in a case where resin materials such as polyimide and polyphenylenebenzo bisoxazole described above are used as the release layer 7, the laser power is set to 0.01 to 1 [J/cm²]. Accordingly, the release layer 7 with a film thickness of about 0.1 μm is completely ablated and in addition, the light emitting device 15 is not damaged by the light irradiation.

Next, as show in FIG. 2D, the first substrate 11 and the second substrate 17 are separated from each other. By this separation, the light emitting device 15 from which the release layer 7 has been removed by ablation adheres to the adhesive layer 19 of the second substrate 17 and is transferred to the second substrate 17 side. At this time, the bonding layer 9 is left on the first substrate 11. On the other hand, the other light emitting devices 15 that have not become a target of the light irradiation are left on the first substrate 11 side while fixedly adhering to the bonding layer 9 whose bonding force is larger than that of the adhesive layer 19. Thus, a part of the light emitting devices 15 formed on the first substrate 11 is selectively transferred onto the second substrate 17.

It should be noted that in the figures, only one light emitting device 15 is selectively transferred onto the second substrate 17. However, it is possible to selectively transfer, onto the second substrate 17, a plurality of light emitting devices 15 arranged on the first substrate 11 at intervals of every several devices, for example, by selectively performing the light irradiation onto the plurality of light emitting devices 15 arranged on the first substrate 11 in the previous process. As a result, the light emitting devices 15 are rearranged on the second substrate 17 in a state where array intervals on the growth substrate 1 and the first substrate 11 are enlarged into a predetermined state.

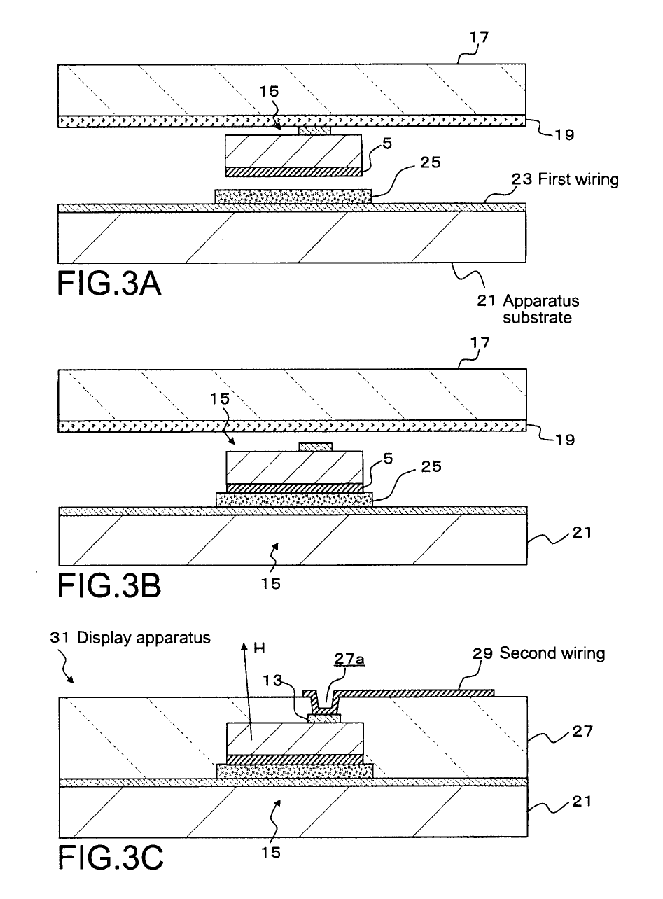

Next, as shown in FIG. 3A, an apparatus substrate 21 is arranged to face the surface of the second substrate 17 onto which the light emitting device 15 has been transferred. First wiring 23 and a conductive bonding layer 25 are formed by patterning on the apparatus substrate 21. Then, the surface of the second substrate 17 onto which the light emitting device 15 has been transferred is faced to the surface of the apparatus substrate 21 on which the first wiring 23 and the conductive bonding layer 25 have been formed, and the light emitting device 15 and the conductive bonding layer 25 are aligned with each other one on one.

In this state, the apparatus substrate 21 and the second substrate 17 are press-fitted to each other, and thus the conductive bonding layer 25 and the first electrode 5 of the light emitting device 15 are bonded to each other.

As shown in FIG. 3B, the apparatus substrate 21 and the second substrate 17 are then separated from each other. Accordingly, all the light emitting devices 15 on the second substrate 17 side are transferred onto the apparatus substrate 21.

After the above processes, an interlayer insulating film 27 is formed on the apparatus substrate 21 with the light emitting devices 15 being embedded into the interlayer insulating film 27. A connection hole 27a is formed in the interlayer insulating film 27 so that the second electrode 13 of the light emitting device 15 is exposed. At this time, since the release layer 7 and the bonding layer 9 are not left on the second electrode 13 of the light emitting device 15, it is possible to form the interlayer insulating film 27 without performing a remove process of those layers and also form the connection hole 27a by only etching the interlayer insulating film 27.

Subsequently, second wiring 29 connected to the second electrode 13 via the connection hole 27a is formed on the interlayer insulating film 27, thus completing a display apparatus 31.

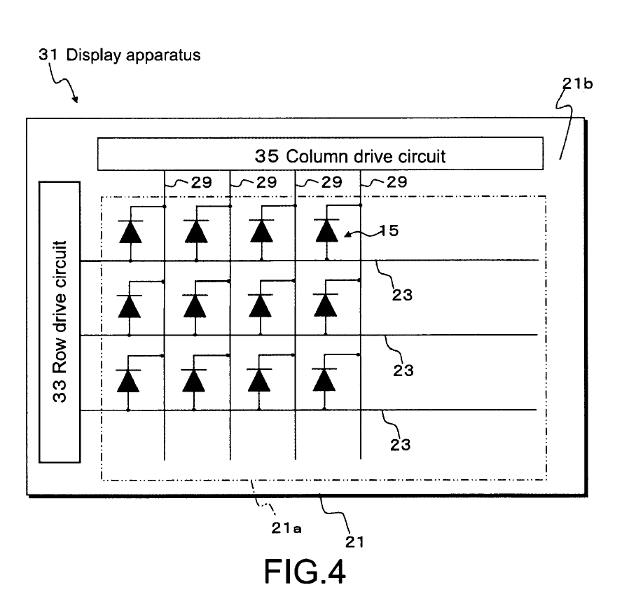

FIG. 4 shows an example of a circuit structure of the display apparatus 31 formed as described above. As shown in FIG. 4, a display area 21a and its circumferential area 21b are set on the apparatus substrate 21 of the display apparatus 31. In the display area 21a, a plurality of first wires 23 and second wires 29 are arranged in rows and columns, and the display area 21a is structured as a pixel array portion in which pixel portions including the light emitting devices 15 described above are provided so as to correspond to respective intersecting portions of the wires. Further, in the circumferential area 21b, a row drive circuit 33 for scanning and driving the first wires 23 and a column drive circuit 35 for supplying signals to the second wires 29 are arranged.

Then, a light emitting device 15 in a row that is selected by the row drive circuit 33 is supplied with a signal from the column drive circuit 35, and the light emitting device 15 emits light with luminance based on the signal.

It should be noted that the structure of the pixel circuit as described above is merely an example, and may be provided with a pixel circuit using driving thin film transistors or capacitive elements in pixels as appropriate to thus obtain active matrix driving.

The procedure of the first embodiment described above provides the structure in which, in the transfer of the light emitting device 15 that has been described with reference to FIG. 2C, the release layer 7 provided on the light emitting device 15 side with respect to the bonding layer 9 is ablated and the light emitting device 15 is transferred from the first substrate 11 onto the second substrate 17. With this structure, the light emitting device 15 can be transferred onto the second substrate 17 with the bonding layer 9 being left on the first substrate 11 as shown in FIG. 2D. In addition, by providing the bonding layer 9 and the release layer 7 separately, it is possible to reliably transfer the light emitting device 15 owing to the release layer 7 that is formed by selecting a material that has a wide appropriate range of laser energy for ablation and is easy to be ablated, while sufficiently ensuring bonding property between the first substrate 11 and the light emitting device 15 owing to the bonding layer 9.

As a result, the light emitting device 15 for which bonding property with the first substrate 11 is ensured can be subjected to processing treatment on the first substrate 11, for example. Further, since the light emitting device 15 can be transferred onto the second substrate 17 without the bonding layer 9 being left on the light emitting device 15 side, a remove process of the bonding layer 9 is not necessary after the transfer, which can simplify the procedure of the processes.

### 2. Second Embodiment

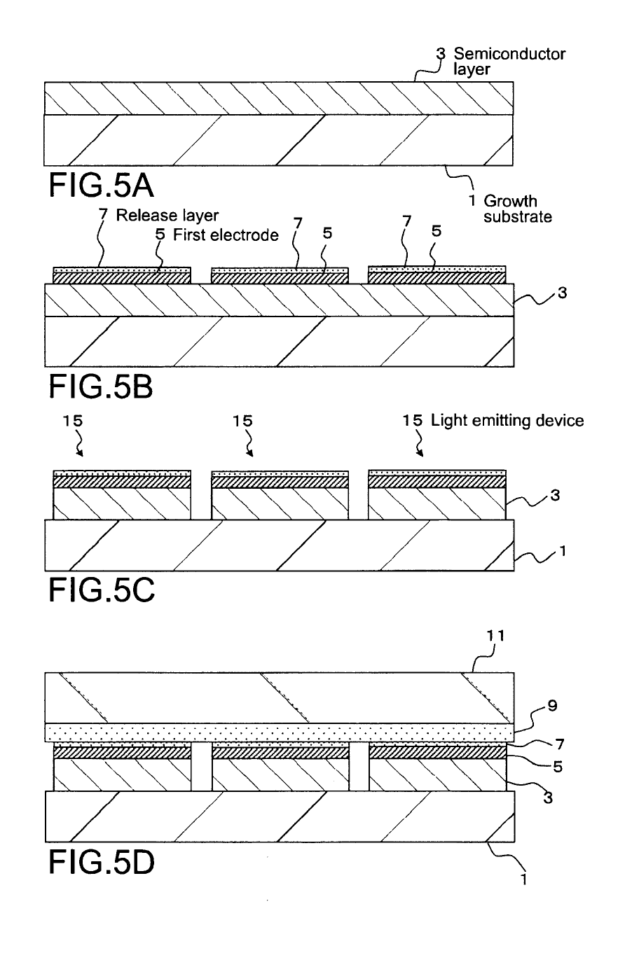

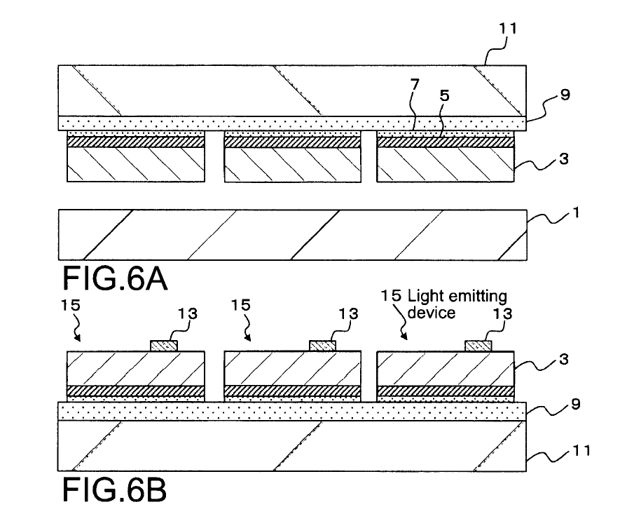

A second embodiment shown in FIGS. 5 and 6 is different from the first embodiment in the manufacturing procedure up to the process of laminating and arranging in the stated order the release layers 7 and the light emitting devices 15 on the first substrate 11 having light transmitting property, via the bonding layer 9 having light transmitting property. The processes subsequent to that process are the same as those in the first embodiment. Hereinafter, the manufacturing procedure of the second embodiment will be described with reference to FIGS. 5 and 6. It should be noted that descriptions overlapping with the first embodiment will be omitted.

First, as shown in FIG. 5A, the compound semiconductor layer of the first conductivity type (for example, n-type), the active layer, and the compound semiconductor layer of the second conductivity type (for example, p-type) are epitaxially grown in the stated order on the growth substrate 1 for growing semiconductor crystal, the growth substrate 1 being made of sapphire or the like, to thereby form the semiconductor layer 3. This process is performed in the same manner as described with reference to FIG. 1A in the first embodiment.

Next, as shown in FIG. 5B, the first electrodes 5 and the release layers 7 are formed and arranged on the semiconductor layer 3. This process is performed in the same manner as described with reference to FIG. 1B in the first embodiment.

After that, as shown in FIG. 5C, device isolation is performed on the growth substrate 1 by pattern-etching the semiconductor layer 3, to thereby obtain a state where the plurality of light emitting devices (light emitting diodes) 15 are formed and arranged on the growth substrate 1. It should be noted that those light emitting devices 15 are not provided with second electrodes.

Then, as shown in FIG. 5D, the first substrate 11 is bonded to the growth substrate 1 on which the semiconductor layers 3, the first electrodes 5, and the release layers 7 have been formed and subjected to the device isolation, via the uncured bonding layer 9. It is assumed that the bonding layer 9 and the first substrate 11 are the same as those in the first embodiment. After the growth substrate 1 and the first substrate 11 are bonded to each other, the bonding layer 9 is cured.

Next, as shown in FIG. 6A, the growth substrate 1 is separated and removed from the semiconductor layers 3 and then the release layers 7, the first electrodes 5, and the semiconductor layers 3 are transferred onto the first substrate 11. In this case, the growth substrate 1 is separated and removed from the semiconductor layers 3 by ablating the interfaces between the growth substrate 1 and the semiconductor layers 3 due to laser irradiation from the growth substrate 1 side.

After that, as shown in FIG. 6B, the second electrode 13 is formed and arranged on each of the semiconductor layers 3. The second electrode 13 is formed in the same manner as described in the first embodiment with reference to FIG. 1B.

Through the above processes, each of the release layers 7 and each of the light emitting devices 15 provided with the second electrode 13 are laminated on the first substrate 11 having light transmitting property in the stated order via the bonding layer 9 having light transmitting property.

After the above, the same processes are performed as those described in the first embodiment with reference to FIGS. 2C to 3C. Thus, a part of the light emitting devices 15 formed on the first substrate 11 is selectively transferred onto the second substrate 17 and thereafter transferred onto the apparatus substrate 21 on which the first wiring 23 and the conductive bonding layer 25 are formed by patterning, to thereby complete the display apparatus 31 including the interlayer insulating film 27 and the second wires 29 formed therein.

Even in the second embodiment described above, the light emitting device 15 is transferred in the same manner as in the first embodiment as described with reference to FIG. 2C. Accordingly, it is possible to reliably transfer the light emitting device 15 owing to the release layer 7 that is easy to be ablated while sufficiently ensuring bonding property between the first substrate 11 and the light emitting device 15 owing to the bonding layer 9 as in the first embodiment.

It should be noted that in the first embodiment and the second embodiment described above, the method of transferring the light emitting device (light emitting diode) 15 in the manufacturing process of the display apparatus has been described. However, a device that is selectively transferred between a first substrate and a second substrate by ablation is not limited to the above device, and may be a light emitting device other than the light emitting diode for the manufacture of a display apparatus. Further, the method of transferring a device according to the embodiments of the present invention is not limited to the application to the manufacture of a display apparatus. In this case, the device may be a device other than a light emitting device, such as a resistance device, a switching device, a piezoelectric device, and a packaged device combining those devices, and the same effect as in the embodiments of the present invention can be obtained.

The present application contains subject matter related to that disclosed in Japanese Priority Patent Application JP 2009-017468 filed in the Japan Patent Office on Jan. 29, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A method of transferring a device, comprising:
arranging a release layer and a device in the stated lamination order on a first substrate having light transmitting property via a bonding layer having light transmitting property;
arranging an adhesive layer formed on a second substrate so that the adhesive layer is opposed to a surface of the first substrate on which the device is arranged; and
ablating the release layer by performing light irradiation onto the release layer from the first substrate side and transferring the device onto the second substrate with the bonding layer being left on the first substrate.

2. The method of transferring a device according to claim 1,
wherein the release layer is formed of a resin material, and
wherein the light irradiation is performed at energy by which the release layer is completely ablated.

3. The method of transferring a device according to claim 1,
wherein the bonding layer is formed of one of a material containing at least one of fluorine (F) and silicon (Si) and that formed of an ionomer resin, and
wherein the light irradiation is performed using a pulse laser beam having a wavelength of 450 nm or less.

4. The method of transferring a device according to claim 1,
wherein an interface of the device on the release layer side includes an electrode formed of a metal material, and
wherein the electrode functions as a photothermal conversion layer in the light irradiation.

5. A method of manufacturing a display apparatus, comprising:
arranging a release layer and a light emitting device in the stated lamination order on a first substrate having light transmitting property via a bonding layer having light transmitting property;
arranging an adhesive layer formed on a second substrate so that the adhesive layer is opposed to a surface of the first substrate on which the light emitting device is arranged; and
ablating the release layer by performing light irradiation on the release layer from the first substrate side and transferring the light emitting device onto the second substrate with the bonding layer being left on the first substrate.
